(19) United States
(12) Patent Application Publication
(10) Pub. No.: US 2026/0288043 A1
(43) Pub. Date: Sep. 24, 2026

(54) RECORDING MEDIUM SUPPLY DEVICE AND IMAGE FORMING APPARATUS

(71) Applicant: FUJIFILM Business Innovation Corp., Tokyo (JP)

(72) Inventor: Yuichi ARAKI, Kanagawa (JP)

(73) Assignee: FUJIFILM Business Innovation Corp., Tokyo (JP)

(21) Appl. No.: 19/270,438

(22) Filed: Jul. 15, 2025

(30) Foreign Application Priority Data
Mar. 24, 2025 (JP) 2025-048627

(51) Int. Cl. G03G 15/00

(52) U.S. Cl. CPC G03G 15/6511; G03G 2215/00734; G03G 2215/00742; G03G 2215/00751

(57) ABSTRACT

A recording medium supply device includes: an accommodation portion that accommodates multiple stacked recording media; a first blowing unit that blows air at a first position on a periphery of the recording media accommodated in the accommodation portion; a second blowing unit that blows air at a second position different from the first position on the periphery of the recording media accommodated in the accommodation portion to overlap an air flow path through the first blowing unit; a first detection unit that detects a floating state of the recording media at the first position; a second detection unit that detects a floating state of the recording media at the second position; and an adjustment unit that adjusts an air volume by one of the first blowing unit and the second blowing unit based on detection results by the first detection unit and the second detection unit.

### CROSS-REFERENCE TO RELATED APPLICATIONS

This application is based on and claims priority under 35 USC 119 from Japanese Patent Application No. 2025-048627 filed Mar. 24, 2025.

### BACKGROUND

### (i) Technical Field

The present invention relates to a recording medium supply device and an image forming apparatus.

### (ii) Related Art

JP2011-140359A discloses a paper feeding device that includes a separation air blowing unit in front of a paper stacking tray and floating air blowing units on both sides of the paper stacking tray, and adjusts the air volume according to the behavior of the paper that receives the air.

### SUMMARY

A recording medium supply device may include a plurality of blowing units that blow air onto a recording medium accommodated in an accommodation portion to make the recording medium float. In such a recording medium supply device, in a case in which air flow paths through the plurality of blowing units overlap, adjusting the air volume by the plurality of blowing units in parallel may result in the air from the plurality of blowing units affecting each other, and the air volume may be excessively adjusted.

Aspects of non-limiting embodiments of the present disclosure relate to a recording medium supply device and an image forming apparatus that suppress excessive adjustment of the air volume by a blowing unit, compared to a case in which adjustment of the air volume by a plurality of blowing units whose air flow paths overlap is performed in parallel.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium supply device including: an accommodation portion that accommodates a plurality of stacked recording media; a first blowing unit that blows air at a first position on a periphery of the recording media accommodated in the accommodation portion; a second blowing unit that blows air at a second position different from the first position on the periphery of the recording media accommodated in the accommodation portion to overlap an air flow path through the first blowing unit; a first detection unit that detects a floating state of the recording media at the first position; a second detection unit that detects a floating state of the recording media at the second position; and an adjustment unit that adjusts an air volume by one of the first blowing unit and the second blowing unit based on detection results by the first detection unit and the second detection unit.

### BRIEF DESCRIPTION OF THE DRAWINGS

Exemplary embodiment(s) of the present invention will be described in detail based on the following figures, wherein:

FIG. 1 is a diagram showing an image forming apparatus to which the present exemplary embodiment is applied;

FIG. 2 is a diagram showing a configuration example of hardware of a control unit;

FIG. 3 is a schematic diagram for describing a configuration of a paper accommodating device, and is a cross-sectional view of III-III portion in FIG. 1;

FIG. 4 is a view of the paper accommodating device as viewed in a direction IV in FIG. 3;

FIG. 5 is a flowchart showing an example of a procedure in which a control unit adjusts the air volume of a first blowing unit or a second blowing unit;

FIG. 6 is a diagram showing a first modification example of the configuration of the paper accommodating device, and is a view showing the paper accommodating device as viewed from a downstream side in a z direction; and

FIG. 7 is a diagram showing a second modification example of the configuration of the paper accommodating device, and is a view showing the paper accommodating device as viewed from the downstream side in the z direction.

### DETAILED DESCRIPTION

Hereinafter, exemplary embodiments of the present invention will be described with reference to the accompanying drawings.

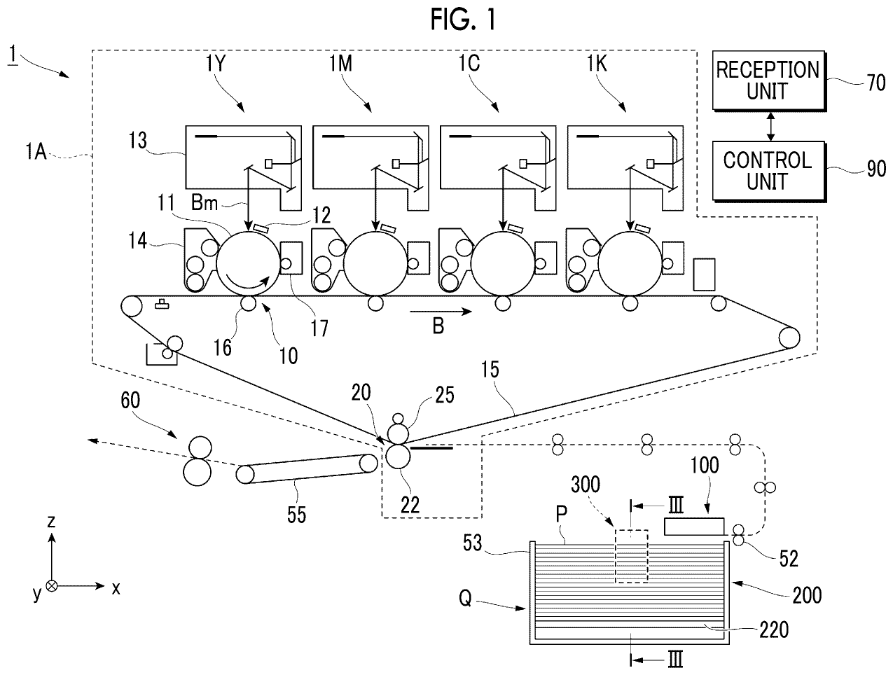

FIG. 1 is a diagram showing an image forming apparatus 1 to which the present exemplary embodiment is applied. In the following description, a direction from left to right in FIG. 1 is represented as an x direction, a direction from the front to the back of the page as a y direction, and a direction from bottom to top as a z direction.

The image forming apparatus 1 shown in FIG. 1 is an intermediate transfer type image forming apparatus 1 called a tandem type. The image forming apparatus 1 is provided with a paper accommodating device 200 that accommodates paper P which is an example of a recording medium.

Further, the image forming apparatus 1 is provided with an image forming section 1A. The image forming section 1A forms an image on the paper P sent out from the paper accommodating device 200.

The image forming section 1A is provided with a plurality of image forming units 1Y, 1M, 1C, and 1K. Each of the plurality of image forming units 1Y, 1M, 1C, and 1K uses an electrophotographic method to form a toner image of each color component.

In addition, the image forming section 1A is provided with a primary transfer unit 10. The toner images of the respective colors formed by the image forming units 1Y, 1M, 1C, and 1K are transferred onto an intermediate transfer belt 15 by the primary transfer unit 10.

In addition, the image forming section 1A is provided with a secondary transfer unit 20. The toner images transferred onto the intermediate transfer belt 15 are transferred onto the paper P by the secondary transfer unit 20.

In addition, the image forming apparatus 1 is also provided with a fixing device 60 that fixes, onto the paper P, the toner image secondarily transferred onto the paper P.

Further, the image forming apparatus 1 is provided with a control unit 90. In the present exemplary embodiment, a CPU provided in the control unit 90 processes information about the paper accommodating device 200. In the present exemplary embodiment, the control unit 90 and the paper accommodating device 200 constitute a recording medium supply device. The control unit 90 is an example of an adjustment unit.

The image forming apparatus 1 is further provided with a reception unit 70 that receives information input by a user.

The reception unit 70 is configured by, for example, a touch panel. The reception unit 70 has a reception function of receiving information from the user, as well as a display function of displaying the information.

A device for realizing the reception function and a device for realizing the display function may be individually provided.

### Configuration of Control Unit

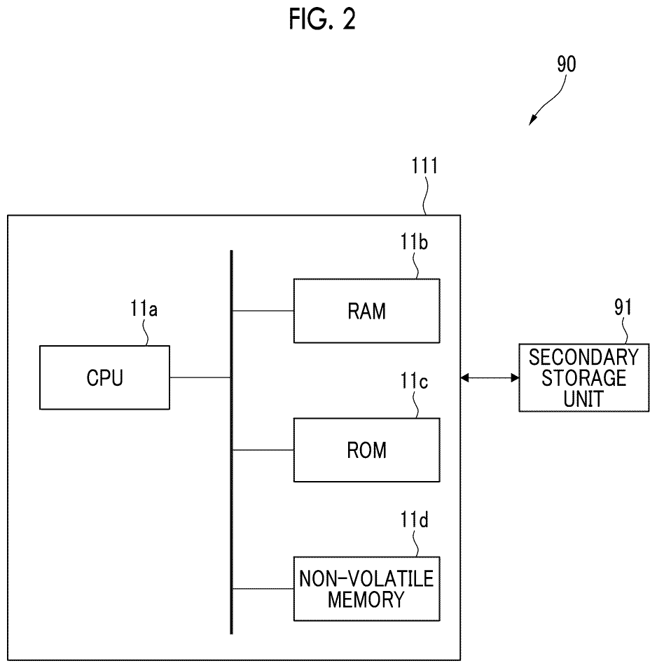

FIG. 2 is a diagram showing a hardware configuration example of the control unit 90. The control unit 90 is implemented by a computer.

The control unit 90 includes an arithmetic processing unit 111 that executes digital arithmetic processing according to a program, and a secondary storage unit 91 that stores information.

The secondary storage unit 91 is realized, for example, by a known information storage device such as a hard disk drive (HDD), a semiconductor memory, or a magnetic tape.

The arithmetic processing unit 111 is provided with a CPU 11a which is an example of a processor.

Further, the arithmetic processing unit 111 is provided with a RAM 11b that is used as a work memory or the like of the CPU 11a. Furthermore, the arithmetic processing unit 111 is provided with a ROM 11c in which a program and the like executed by the CPU 11a are stored.

The arithmetic processing unit 111 is also provided with a non-volatile memory 11d that can retain data even in a case in which power supply is interrupted.

The non-volatile memory 11d is configured by, for example, an SRAM or a flash memory that is backed up by a battery. The secondary storage unit 91 stores various types of information such as a program executed by the arithmetic processing unit 111.

In the present exemplary embodiment, the CPU 11a of the arithmetic processing unit 111 reads the program stored in the ROM 11c or the secondary storage unit 91. The CPU 11a executes the program stored in the ROM 11c or the secondary storage unit 91. Accordingly, various processes performed by the image forming apparatus 1 are executed. Various processes performed by the image forming apparatus 1 are executed by the CPU 11a.

The program executed by the CPU 11a can be provided to the image forming apparatus 1 via a recording medium.

Examples of the recording medium include a magnetic recording medium such as a magnetic tape or a magnetic disk. Examples of the recording medium also include an optical recording medium such as an optical disc.

Examples of the recording medium also include a magneto-optical recording medium. Examples of the recording medium also include a semiconductor memory.

Further, the program executed by the CPU 11a may be provided to the image forming apparatus 1 by using communication means such as the Internet.

The image forming apparatus 1 will be further described with reference to FIG. 1.

The following devices are installed in each of the image forming units 1Y, 1M, 1C, and 1K.

First, a photosensitive drum 11 that rotates in an arrow A direction is provided. A charging device 12 that charges the photosensitive drum 11 is provided around the photosensitive drum 11. In addition, an exposure device 13 that forms an electrostatic latent image on the photosensitive drum 11 is provided. Furthermore, a developing device 14 that develops the electrostatic latent image on the photosensitive drum 11 with a toner is provided.

Each of the image forming units 1Y, 1M, 1C, and 1K is provided with a primary transfer roll 16. The primary transfer roll 16 is provided at the primary transfer unit 10. The toner image formed on the photosensitive drum 11 is transferred onto the intermediate transfer belt 15 by the primary transfer roll 16.

Further, each of the image forming units 1Y, 1M, 1C, and 1K is provided with a drum cleaner 17. The drum cleaner 17 removes residual toner remaining on the photosensitive drum 11.

The intermediate transfer belt 15 circulates in an arrow B direction shown in FIG. 1 at a predetermined speed.

The primary transfer unit 10 includes the primary transfer rolls 16 that are disposed opposite the photosensitive drums 11 with the intermediate transfer belt 15 interposed therebetween.

In the present exemplary embodiment, the toner images on the photosensitive drums 11 are sequentially electrostatically attracted onto the intermediate transfer belt 15. Accordingly, a superimposed toner image is formed on the intermediate transfer belt 15.

The secondary transfer unit 20 includes a secondary transfer roll 22 and a backup roll 25 that are disposed opposite an outer peripheral surface of the intermediate transfer belt 15.

The secondary transfer roll 22 is pressed against the backup roll 25 with the intermediate transfer belt 15 interposed therebetween. A voltage is applied between the secondary transfer roll 22 and the backup roll 25. In the present exemplary embodiment, the toner images on the intermediate transfer belt 15 are transferred onto the paper P transported to the secondary transfer unit 20.

In the present exemplary embodiment, the paper P sent out from the paper accommodating device 200 is transported to the secondary transfer unit 20. The toner images on the intermediate transfer belt 15 are transferred onto the paper P sent out from the paper accommodating device 200.

In the present exemplary embodiment, image data is output to the image forming apparatus 1 from an image reading device (not shown) or a personal computer (PC) or the like.

Then, the image data is subjected to image processing by an image processing apparatus (not shown). Accordingly, image data for four colors Y, M, C, and K is generated. The generated image data is output to the exposure device 13 provided for each of the colors Y, M, C, and K.

The exposure device 13 irradiates the photosensitive drum 11 with light in accordance with input image data.

The exposure device 13 uses, for example, a semiconductor laser to expose the photosensitive drum 11. In addition, the exposure device 13 uses, for example, a light emitting diode (LED) to expose the photosensitive drum 11.

A surface of each photosensitive drum 11 is charged by the charging device 12. Thereafter, the surface is scanned and exposed by the exposure device 13, and an electrostatic latent image is formed on this surface.

Next, the toner is adhered to the photosensitive drum 11 by the developing device 14. Accordingly, toner images are formed on the photosensitive drums 11.

The toner images formed on the photosensitive drum 11 are transferred onto the intermediate transfer belt 15 in the primary transfer unit 10.

After the toner images are transferred onto a surface of the intermediate transfer belt 15, the toner images are moved to the secondary transfer unit 20 by the moving intermediate transfer belt 15.

In the secondary transfer unit 20, the secondary transfer roll 22 is pressed against the backup roll 25 via the intermediate transfer belt 15.

In the present exemplary embodiment, the paper P sent out from the paper accommodating device 200 is sandwiched between the intermediate transfer belt 15 and the secondary transfer roll 22.

Accordingly, an unfixed toner image held on the intermediate transfer belt 15 is transferred onto the paper P by the secondary transfer unit 20. Thereafter, the paper P onto which the toner image is transferred passes through the fixing device 60 and is discharged to a paper discharge unit (not shown).

### Description of Paper Accommodating Device

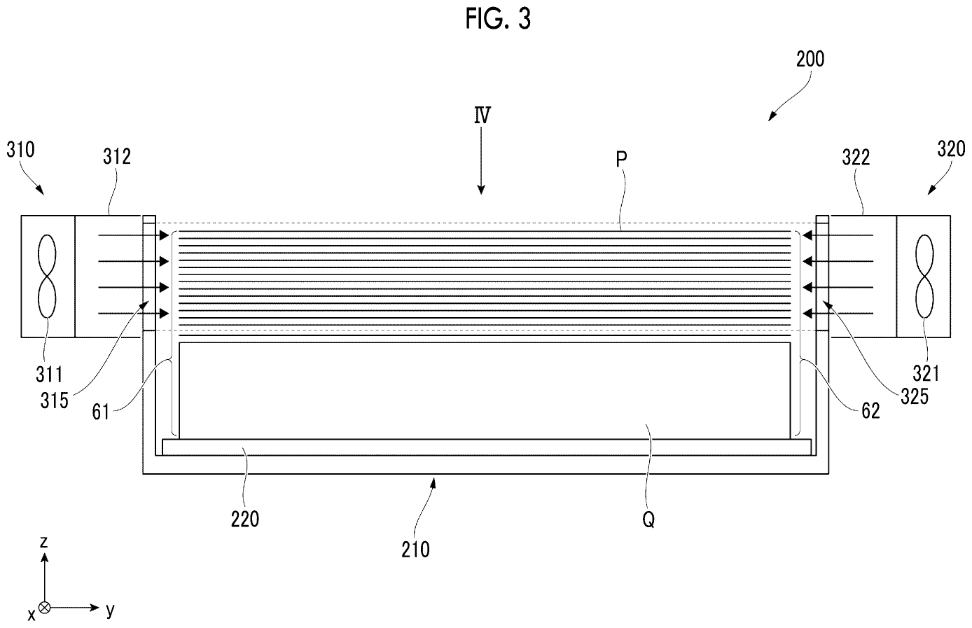

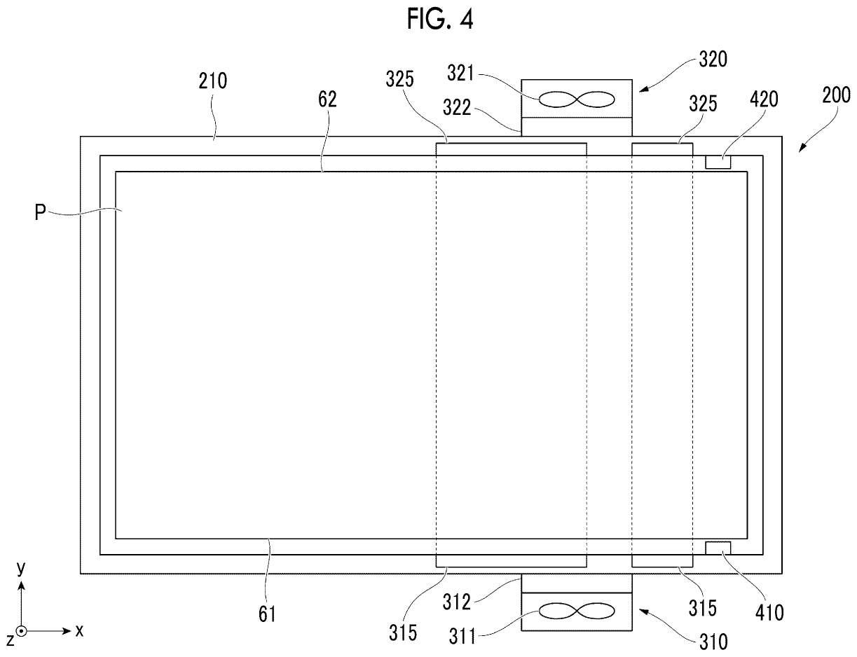

FIG. 3 is a schematic diagram for describing the configuration of the paper accommodating device 200, and is a cross-sectional view of III-III portion in FIG. 1. FIG. 4 is a view of the paper accommodating device 200 as viewed in a direction IV in FIG. 3.

The paper accommodating device 200 includes an accommodation portion 210 that accommodates a paper stack Q in which a plurality of sheets of paper P are stacked. The accommodation portion 210 is provided with a support stand 220 that supports the accommodated paper stack Q from below.

Above the paper stack Q accommodated in the paper accommodating device 200, there is provided a suction unit 100 (see FIG. 1) that sucks and sends out the paper P constituting the paper stack Q. Furthermore, above the paper stack Q accommodated in the paper accommodating device 200, there is provided a transport roll 52 (see FIG. 1) that transports the paper P sent out by the suction unit 100 toward the image forming section 1A (see FIG. 1).

The paper accommodating device 200 also includes a first blowing unit 310 and a second blowing unit 320 that blow air toward the periphery of the paper stack Q accommodated in the accommodation portion 210 to separate the paper P from the paper stack Q.

In this example, the first blowing unit 310 is provided on an upstream side in the y direction, that is, on the front side of the image forming apparatus 1 (see FIG. 1). The second blowing unit 320 is provided on a downstream side in the y direction, that is, on the rear side of the image forming apparatus 1.

The first blowing unit 310 includes an air blowing member 311 that blows out high-pressure air by rotating blades. The air generated by the first blowing unit 310 is blown against the periphery of the paper stack Q accommodated in the accommodation portion 210 via a duct 312 connected to the air blowing member 311 and an opening 315 formed in the accommodation portion 210.

In this example, the air generated by the first blowing unit 310 is blown out from the opening 315 toward the downstream side in the y direction into the accommodation portion 210 and blown onto a first edge portion 61 located on the upstream side in the y direction of the periphery of the paper P that constitutes the paper stack Q. The first edge portion 61 is an example of a first position on the periphery of the recording medium.

Similarly to the first blowing unit 310, the second blowing unit 320 includes an air blowing member 321. The air generated by the second blowing unit 320 is blown against the periphery of the paper stack Q accommodated in the accommodation portion 210 via a duct 322 connected to the air blowing member 321 and an opening 325 formed in the accommodation portion 210.

In this example, the air generated by the second blowing unit 320 is blown out from the opening 325 toward the upstream side in the y direction into the accommodation portion 210 and blown onto a second edge portion 62 located on the downstream side in the y direction of the periphery of the paper stack Q. The second edge portion 62 is an example of a second position on the periphery of the recording medium.

In a case in which air is blown onto the paper stack Q accommodated in the accommodation portion 210, a plurality of sheets of paper P on the upper side (downstream side in the z direction) among the sheets of the paper P that constitutes the paper stack Q are floated. Accordingly, the plurality of sheets of paper P on the upper side are separated from the paper stack Q.

Furthermore, the air blown onto the first edge portion 61 of the paper P by the first blowing unit 310 passes between the floated sheets of paper P and flows within the accommodation portion 210 from the upstream side to the downstream side in the y direction.

Similarly, the air blown onto the second edge portion 62 of the paper P by the second blowing unit 320 passes between the floated sheets of paper P and flows within the accommodation portion 210 from the downstream side to the upstream side in the y direction.

Here, in the paper accommodating device 200 according to the present exemplary embodiment, the opening 315 through which the air generated by the first blowing unit 310 is blown out and the opening 325 through which the air generated by the second blowing unit 320 is blown out are opposed to each other across the internal space of the accommodation portion 210. Accordingly, the air flow path through the first blowing unit 310 and the air flow path through the second blowing unit 320 overlap each other.

In the present exemplary embodiment, the air flow path through the first blowing unit 310 is a range surrounded by an extension line extending from the outer periphery of the opening 315 toward the downstream side in the y direction, which is the air flow direction. Similarly, the air flow path through the second blowing unit 320 is a range surrounded by an extension line extending from the outer periphery of the opening 325 toward the upstream side in the y direction, which is the air flow direction. In FIGS. 3 and 4, the air flow paths through the first blowing unit 310 and the second blowing unit 320 are shown by broken lines.

In this example, the entire area of the air flow path through the first blowing unit 310 and the entire area of the air flow path through the second blowing unit 320 overlap each other. In addition, the air flow path through the first blowing unit 310 and the air flow path through the second blowing unit 320 overlap in the z direction, which is the stacking direction of the paper P, and in the x direction, which is the surface direction of the paper P.

In a case in which the sheets of paper P are separated from the paper stack Q by the air from the first blowing unit 310 and the second blowing unit 320, the uppermost paper P is sucked into the suction unit 100 and sent out from the paper accommodating device 200. Then, the paper P sent out from the paper accommodating device 200 by the suction unit 100 is transported toward the image forming section 1A by the transport roll 52, which are an example of a transport section.

The paper accommodating device 200 includes a first imaging unit 410 and a second imaging unit 420 that capture an image of the paper P floated from the paper stack Q by air from the first blowing unit 310 and the second blowing unit 320. The first imaging unit 410 is an example of a first detection unit, and the second imaging unit 420 is an example of a second detection unit.

In this example, the first imaging unit 410 is provided on the upstream side in the y direction, that is, on the front side of the image forming apparatus 1. Then, the first imaging unit 410 captures an image of a first edge portion 61 of the periphery of the paper P floated from the paper stack Q, the first edge portion 61 being located on the upstream side in the y direction.

The second imaging unit 420 is provided on the downstream side in the y direction, that is, on the rear side of the image forming apparatus 1. Then, the second imaging unit 420 captures an image of a second edge portion 62 of the periphery of the paper P floated from the paper stack Q, the second edge portion 62 being located on the downstream side in the y direction.

The first imaging unit 410 and the second imaging unit 420 are so-called cameras. The first imaging unit 410 and the second imaging unit 420 are configured by, for example, charge coupled devices (CCDs) or a complementary metal oxide semiconductor (CMOS). As the imaging unit 400, a monochrome camera or a color camera may be used. Further, the first imaging unit 410 and the second imaging unit 420 may be contact image sensors.

### Adjustment of Air Volume of Air Blown Out From First Blowing Unit and Second Blowing Unit

In the paper accommodating device 200, the position in the z direction of the paper P that is separated from the paper stack Q and floats up varies depending on the air volume of air blown onto the periphery of the paper stack Q from the first blowing unit 310 and the second blowing unit 320. In the following description, the position in the z direction of the paper P that is separated from the paper stack Q and floats up may be referred to as the floating position of the paper P.

The paper P that has been separated from the paper stack Q and is floating drops in a case in which the air volume by the first blowing unit 310 and the second blowing unit 320 decreases. Accordingly, the floating position of the paper P becomes lower, and the intervals between the sheets of paper P that have been separated from the paper stack Q and are floating become narrower.

Furthermore, the paper P that has been separated from the paper stack Q and is floating will be floated further upwards in a case in which the air volume by the first blowing unit 310 and the second blowing unit 320 increases. Accordingly, the floating position of the paper P becomes higher, and the intervals between the sheets of paper P that have been separated from the paper stack Q and are floating become wider.

On the other hand, in a case in which the air volume by the first blowing unit 310 and the second blowing unit 320 further increases, the plurality of sheets of paper P on the upper side among the sheets of paper P that have been separated from the paper stack Q and are floating may overlap and form a stack.

In the present exemplary embodiment, the control unit 90 adjusts the air volume of air blown out from the first blowing unit 310 and the second blowing unit 320. In addition, the control unit 90 adjusts the air volume of air blown out from the first blowing unit 310 and the second blowing unit 320 such that the floating state of the paper P separated from the paper stack Q returns to a predetermined normal state. Here, the normal state is a state in which the uppermost paper P among the sheets of paper P separated from the paper stack Q can be sucked by the suction unit 100 and transported by the transport roll 52 to the image forming section 1A. Examples of such a normal state include a state in which the floating position of the paper P separated from the paper stack Q and the interval between the sheets of paper P are within a predetermined range, and a stack of the plurality of sheets of paper P on the upper side is not formed.

The control unit 90 adjusts the air volume of air blown out from the first blowing unit 310 and the second blowing unit 320 based on images of the paper P separated from the paper stack Q captured by the first imaging unit 410 and the second imaging unit 420.

Specifically, the control unit 90 uses an image of the paper P at the first edge portion 61 captured by the first imaging unit 410 to determine whether or not the floating state of the paper P separated from the paper stack Q is normal at the first edge portion 61.

In addition, the control unit 90 uses an image of the paper P at the second edge portion 62 captured by the second imaging unit 420 to determine whether or not the floating state of the paper P separated from the paper stack Q is normal at the second edge portion 62.

For example, the control unit 90 determines that the floating state of the paper P is not normal in a case in which the floating position of the uppermost paper P among the sheets of paper P separated from the paper stack Q is above or below a predetermined range. Furthermore, the control unit 90 determines that the floating state of the paper P is not normal in a case in which the interval between the sheets of paper P is wider or narrower than a predetermined interval. Furthermore, the control unit 90 determines that the state of the paper P is not normal in a case in which a stack of the plurality of sheets of paper P floated on the upper side is formed.

Then, in a case in which the floating state of the paper P at the first edge portion 61 is not normal, the control unit 90 calculates a first adjustment amount, which is an adjustment amount for adjusting the air volume of air blown out from the first blowing unit 310, based on the image of the paper P at the first edge portion 61.

In addition, in a case in which the floating state of the paper P at the second edge portion 62 is not normal, the control unit 90 calculates a second adjustment amount, which is an adjustment amount for adjusting the air volume of air blown out from the second blowing unit 320, based on the image of the paper P at the second edge portion 62.

For example, the control unit 90 calculates a first adjustment amount for reducing the air volume of air blown out from the first blowing unit 310 in a case in which the floating position of the uppermost paper P among the sheets of paper P separated from the paper stack Q is above a predetermined range. Furthermore, the control unit 90 calculates a first adjustment amount for reducing the air volume of air blown out from the first blowing unit 310 in a case in which the interval between the sheets of paper P is wider than a predetermined interval. In addition, the control unit 90 calculates a first adjustment amount for reducing the air volume of air blown out from the first blowing unit 310 in a case in which a stack of the plurality of sheets of paper P floated on the upper side is formed.

In addition, the control unit 90 calculates a first adjustment amount for increasing the air volume of air blown out from the first blowing unit 310 in a case in which the floating position of the uppermost paper P among the sheets of paper P separated from the paper stack Q is below a predetermined range. Furthermore, the control unit 90 calculates a first adjustment amount for increasing the air volume of air blown out from the first blowing unit 310 in a case in which the interval between the sheets of paper P is narrower than a predetermined interval.

The control unit 90 calculates a second adjustment amount in the same manner.

Then, the control unit 90 adjusts the air volume of air blown out from the first blowing unit 310 based on the first adjustment amount. The control unit 90 adjusts the air volume of air blown out from the first blowing unit 310, for example, by adjusting a rotation speed of the air blowing member 311 based on the first adjustment amount.

Similarly, the control unit 90 adjusts the air volume of air blown out from the second blowing unit 320 based on the second adjustment amount. The control unit 90 adjusts the air volume of air blown out from the second blowing unit 320, for example, by adjusting a rotation speed of the air blowing member 321 based on the second adjustment amount.

Here, as described above, in the paper accommodating device 200 according to the present exemplary embodiment, the air flow path through the first blowing unit 310 and the air flow path through the second blowing unit 320 overlap each other.

Therefore, in a case in which the air volume of the first blowing unit 310 and the air volume of the second blowing unit 320 are adjusted in parallel, the air from the first blowing unit 310 and the air from the second blowing unit 320 may affect each other, and the floating state of the paper P may not be able to be adjusted to a normal state.

For example, a case is considered in which the first blowing unit 310 and the second blowing unit 320 are adjusted in parallel based on the first adjustment amount and the second adjustment amount such that the air volume of air blown out from the first blowing unit 310 and the second blowing unit 320 is increased.

The first edge portion 61 of the paper P is affected by the air from the second blowing unit 320 in addition to the air from the first blowing unit 310. As described above, the first adjustment amount is calculated such that the floating state of the paper P at the first edge portion 61 is normal. Therefore, in a case in which the first edge portion 61 is affected by the air from the second blowing unit 320, the air volume of which has been increased by the second adjustment amount, in addition to the air from the first blowing unit 310, the air volume of which has been increased by the first adjustment amount, the air volume of air blown onto the first edge portion 61 becomes excessive. In this case, it is difficult to maintain the floating state of the paper P at the first edge portion 61 in a normal state.

The same applies to the second edge portion 62.

Furthermore, in a case in which the floating state of the paper P cannot be returned to the normal state, it is necessary to adjust the air volume of air blown out from the first blowing unit 310 and the second blowing unit 320 again, and it may take a long time to return the floating state of the paper P to the normal state.

In contrast, in a case in which it is necessary to adjust both the air volume from the first blowing unit 310 and the air volume from the second blowing unit 320, the control unit 90 according to the present exemplary embodiment adjusts the air volume from one of the first blowing unit 310 and the second blowing unit 320 rather than adjusting the air volumes in parallel. Moreover, after adjustment is made on one side, adjustment is made on the other side.

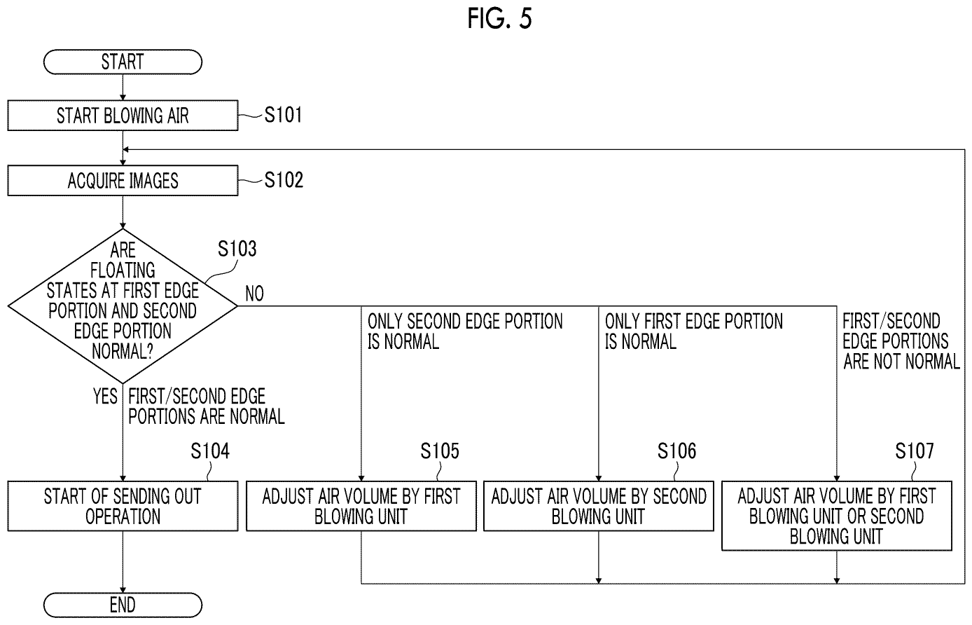

FIG. 5 is a flowchart showing an example of a procedure in which the control unit 90 adjusts the air volume of the first blowing unit 310 or the second blowing unit 320.

In a case in which a user or the like issues an instruction to form an image on the paper P to the image forming apparatus 1, the control unit 90 starts blowing air from the first blowing unit 310 and the second blowing unit 320 (step S101). The air blown out from the first blowing unit 310 and the second blowing unit 320 is blown onto the first edge portion 61 and the second edge portion 62 of the paper stack Q accommodated in the accommodation portion 210, and the plurality of sheets of paper P on the upper side are separated from the paper stack Q.

Next, the control unit 90 acquires an image of the paper P at the first edge portion 61 captured by the first imaging unit 410, and an image of the paper P at the second edge portion 62 captured by the second imaging unit 420 (step S102). In addition, the control unit 90 acquires an image of the paper P at the first edge portion 61 and an image of the paper P at the second edge portion 62 after a predetermined time has elapsed since the first blowing unit 310 and the second blowing unit 320 started blowing air.

Next, the control unit 90 determines whether or not the floating state of the paper P at the first edge portion 61 and the floating state of the paper P at the second edge portion 62 are normal based on the image acquired in step S102 (step S103).

Here, in the present exemplary embodiment, in step S102, the first imaging unit 410 images the first edge portion 61 and the second imaging unit 420 images the second edge portion 62 in parallel. In addition, in step S103, the control unit 90 determines the floating state of the paper P at the first edge portion 61 and the floating state of the paper P at the second edge portion 62 in parallel. Accordingly, it is possible to shorten the time required to determine the floating state of the paper P and to adjust the air volume by the first blowing unit 310 and the second blowing unit 320, compared to a case of performing these tasks sequentially rather than in parallel.

In a case in which both the floating state of the paper P at the first edge portion 61 and the floating state of the paper P at the second edge portion 62 are normal, the control unit 90 starts the operation of sending out the paper P by the paper accommodating device 200 (step S104) and ends the series of processes.

In a case in which the floating state of the paper P at the first edge portion 61 is not normal and the floating state of the paper P at the second edge portion 62 is normal, the control unit 90 calculates a first adjustment amount and adjusts the air volume by the first blowing unit 310 based on the first adjustment amount (step S105). Thereafter, the control unit 90 returns to step S102 and continues the process.

In a case in which the floating state of the paper P at the first edge portion 61 is normal and the floating state of the paper P at the second edge portion 62 is not normal, the control unit 90 calculates a second adjustment amount and adjusts the air volume by the second blowing unit 320 based on the second adjustment amount (step S106). Thereafter, the control unit 90 returns to step S102 and continues the process.

In a case in which both the floating state of the paper P at the first edge portion 61 and the floating state of the paper P at the second edge portion 62 are not normal, the control unit 90 adjusts the air volume by one of the first blowing unit 310 and the second blowing unit 320 (step S107). In addition, in step S107, the control unit 90 does not adjust the air volume of the other of the first blowing unit 310 and the second blowing unit 320. Incidentally, as to whether the air volume of one of the first blowing unit 310 and the second blowing unit 320 is adjusted in step S107, a description will be given later.

Thereafter, the control unit 90 returns to step S102 and continues the process.

As described above, in the present exemplary embodiment, the air volumes of the first blowing unit 310 and the second blowing unit 320, whose air flow paths overlap, are not adjusted in parallel, but only the air volume of one of the first blowing unit 310 and the second blowing unit 320 is adjusted. Accordingly, excessive adjustment of the air volume is suppressed, compared to a case in which the air volumes of the first blowing unit 310 and the second blowing unit 320 are adjusted in parallel. Then, the floating state of the paper P becomes normal at the periphery where air is blown by one of the first blowing unit 310 and the second blowing unit 320.

In addition, after adjusting the air volume by one of the first blowing unit 310 and the second blowing unit 320, in a case in which the floating state of the paper P at the periphery where air is blown by the other of the first blowing unit 310 and the second blowing unit 320 is not normal, the control unit 90 adjusts the air volume by the other.

Accordingly, the floating state of the paper P becomes normal both at the first edge portion 61 to which air is blown by the first blowing unit 310 and at the second edge portion 62 to which air is blown by the second blowing unit 320.

On the other hand, after adjusting the air volume by one of the first blowing unit 310 and the second blowing unit 320, in a case in which the floating state of the paper P becomes normal at both the first edge portion 61 and the second edge portion 62, the control unit 90 does not adjust the air volume by the other. Accordingly, it is possible to shorten the time required to adjust the floating state of the paper P, compared to a case in which the air volume by the other of the first blowing unit 310 and the second blowing unit 320 is adjusted.

Subsequently, a description will be given as to whether the air volume of one of the first blowing unit 310 and the second blowing unit 320 is adjusted in step S107 described above.

In a case in which both the floating state of the paper P at the first edge portion 61 and the floating state of the paper P at the second edge portion 62 are not normal, the control unit 90 calculates a first adjustment amount for adjusting the air volume by the first blowing unit 310 and a second adjustment amount for adjusting the air volume by the second blowing unit 320. Then, the control unit 90 adjusts the air volume by one of the first blowing unit 310 and the second blowing unit 320, which has a larger calculated adjustment amount.

In a case in which the air volume by one of the first blowing unit 310 and the second blowing unit 320 is adjusted, the greater the adjustment amount, the greater the influence on the periphery of the paper P to which air is blown by the other of the first blowing unit 310 and the second blowing unit 320.

In the present exemplary embodiment, by adjusting the air volume by one of the first blowing unit 310 and the second blowing unit 320, which has a larger calculated adjustment amount, it is easier to adjust the floating state of the paper P to a normal state.

Incidentally, in the present exemplary embodiment, in a case in which the floating state of the paper P, the type of the paper P, and the like satisfy predetermined requirements, the air volume by the first blowing unit 310 and the second blowing unit 320 may be adjusted in parallel. In the following description, a mode in which adjustment of the air volume by one of the first blowing unit 310 and the second blowing unit 320 is performed may be referred to as a single adjustment. In addition, in the following description, a mode in which the adjustment of the air volumes of both the first blowing unit 310 and the second blowing unit 320 is performed in parallel may be referred to as a parallel adjustment.

In a case in which a single adjustment is performed, as described above, adjustment of the air volume by one of the first blowing unit 310 and the second blowing unit 320 does not affect the other, and thus excessive adjustment of the air volume is suppressed compared to a parallel adjustment. On the other hand, in the single adjustment, in a case of adjusting the air volume by one of the first blowing unit 310 and the second blowing unit 320 and then adjusting the air volume by the other, it tends to take a long time to adjust the floating state of the paper P.

In contrast, in a case in which a parallel adjustment is performed, it is possible to shorten the time required to adjust the floating state of the paper P compared to a case of the single adjustment.

The control unit 90 may perform a parallel adjustment in a case in which the adjustment amounts of the first blowing unit 310 and the second blowing unit 320, that is, both the first adjustment amount and the second adjustment amount, are equal to or less than a predetermined reference value.

As described above, in a case in which the air volume by one of the first blowing unit 310 and the second blowing unit 320 is adjusted, the greater the adjustment amount, the greater the influence on the other is likely to be. In other words, in a case in which the adjustment amount is small, the adjustment of the air volume by one of the first blowing unit 310 and the second blowing unit 320 is unlikely to affect the other, even in a case in which a parallel adjustment is performed.

Therefore, by performing a parallel adjustment in a case in which the adjustment amounts of the first blowing unit 310 and the second blowing unit 320 are equal to or less than the reference value, the time required to adjust the floating state of the paper P may be shortened.

Furthermore, the control unit 90 may perform either a single adjustment or a parallel adjustment depending on the type of paper P accommodated in the accommodation portion 210.

In a case in which the air volume by one of the first blowing unit 310 and the second blowing unit 320 is adjusted, the degree of the influence on the other may differ depending on the type of paper P. In the present exemplary embodiment, in the case of the paper P for which the influence by the adjustment of the air volume is small, the time required to adjust the floating state of the paper P can be shortened by performing a parallel adjustment. Moreover, in the case of the paper P for which the influence by the adjustment of the air volume is large, excessive adjustment of the air volume is suppressed.

For example, the control unit 90 can perform either a single adjustment or a parallel adjustment depending on the width of the paper P, which is an example of the type of paper P accommodated in the accommodation portion 210. In this example, the width of the paper P is the width in the y direction where the first blowing unit 310 and the second blowing unit 320 are opposed to each other.

The smaller the width of the paper P, the smaller the distance between the first blowing unit 310 and the second blowing unit 320. Therefore, in a case in which the air volume by one of the first blowing unit 310 and the second blowing unit 320 is adjusted, the influence on the other is likely to be greater.

The control unit 90 performs a single adjustment in a case in which the width of the paper P accommodated in the accommodation portion 210 is equal to or smaller than a predetermined reference width. Accordingly, excessive adjustment of the air volume is suppressed. Furthermore, the control unit 90 performs a parallel adjustment in a case in which the width of the paper P accommodated in the accommodation portion 210 exceeds a predetermined reference width. Accordingly, it is possible to shorten the time required to adjust the floating state of the paper P.

Furthermore, the control unit 90 can perform either a single adjustment or a parallel adjustment depending on the basis weight of the paper P, which is an example of the type of paper P accommodated in the accommodation portion 210.

The smaller the basis weight of the paper P, the more easily the floating state of the paper P changes in a case in which the air volume of the blown air is changed. Therefore, the smaller the basis weight of the paper P, in a case in which the air volume by one of the first blowing unit 310 and the second blowing unit 320 is adjusted, the greater the influence on the other is likely to be.

The control unit 90 performs a single adjustment in a case in which the basis weight of the paper P accommodated in the accommodation portion 210 is equal to or less than a predetermined reference amount. Accordingly, excessive adjustment of the air volume is suppressed. Furthermore, the control unit 90 performs a parallel adjustment in a case in which the basis weight of the paper P accommodated in the accommodation portion 210 exceeds a predetermined reference amount. Accordingly, it is possible to shorten the time required to adjust the floating state of the paper P.

Furthermore, the control unit 90 may perform either a single adjustment or a parallel adjustment depending on a selection of a user.

For example, the control unit 90 receives information regarding whether to perform a single adjustment or a parallel adjustment via the reception unit 70 (see FIG. 1), and performs a single adjustment or a parallel adjustment based on the information. Accordingly, the user may adjust the air volume by first blowing unit 310 and second blowing unit 320 in an intended mode.

### Arrangement of First Blowing Unit and Second Blowing Unit

In the paper accommodating device 200 described above, the entire area of the air flow path through the first blowing unit 310 and the entire area of the air flow path through the second blowing unit 320 overlap each other. However, the air flow path through the first blowing unit 310 and the air flow path through the second blowing unit 320 only need to overlap at least in part in the z direction, which is the stacking direction of the paper P, and in either the x direction or the y direction, which is the surface direction of the paper P.

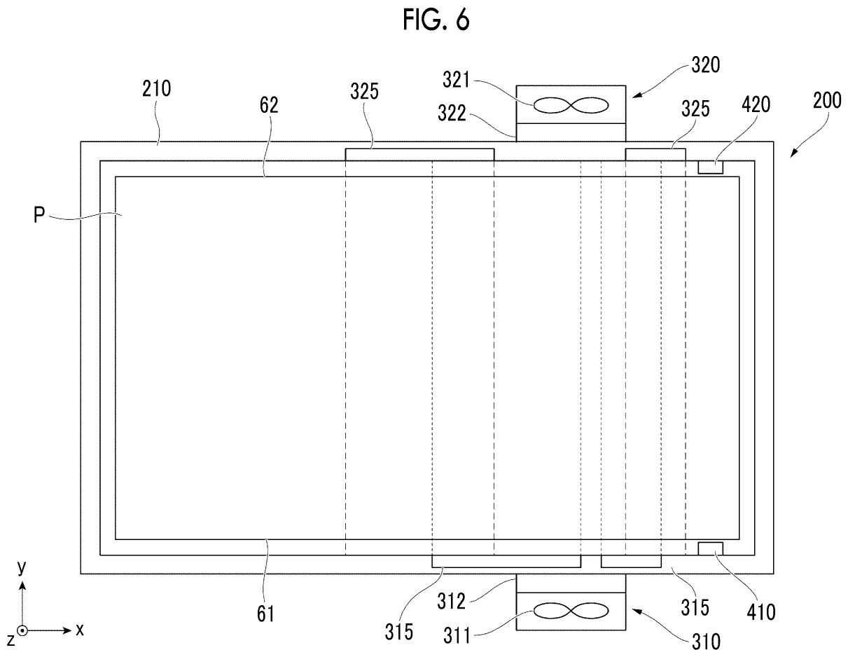

FIG. 6 is a diagram showing a first modification example of the configuration of the paper accommodating device 200, and is a view showing the paper accommodating device 200 as viewed from the downstream side in the z direction.

In the example shown in FIG. 6, the first blowing unit 310 is provided on the upstream side of the accommodation portion 210 in the y direction. Further, the second blowing unit 320 is provided on the downstream side of the accommodation portion 210 in the y direction. In addition, the first blowing unit 310 blows air onto a first edge portion 61 located on the upstream side of the periphery of the paper P in the y direction, and the second blowing unit 320 blows air onto a second edge portion 62 located on the downstream side of the y direction of the periphery of the paper P.

In this example, the opening 315 through which the air generated by the first blowing unit 310 is blown out and the opening 325 through which the air generated by the second blowing unit 320 is blown out are arranged offset in the x direction. Accordingly, the air flow path through the first blowing unit 310 and the air flow path through the second blowing unit 320 overlap in a partial area in the x direction.

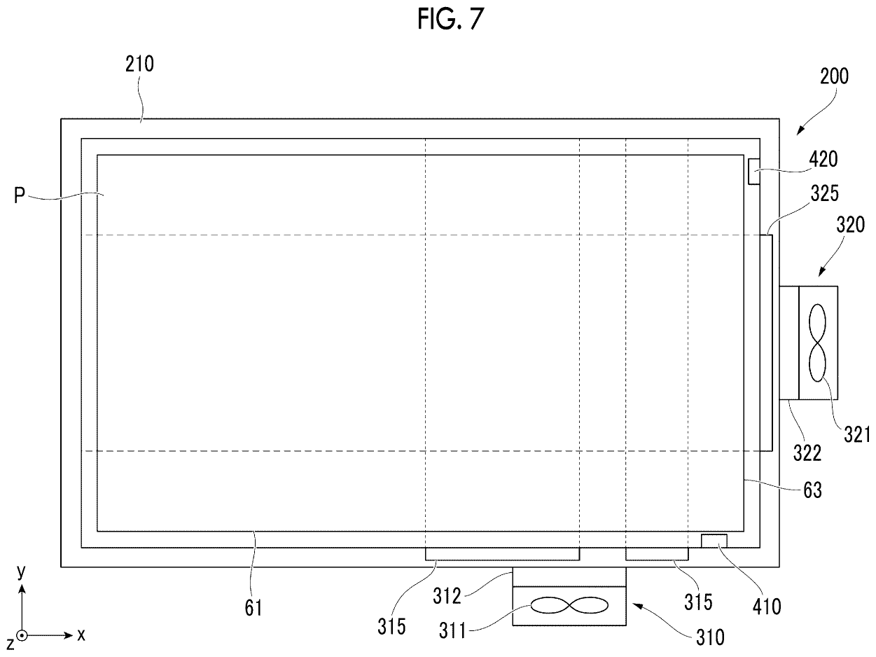

FIG. 7 is a diagram showing a second modification example of the configuration of the paper accommodating device 200, and is a view showing the paper accommodating device 200 as viewed from the downstream side in the z direction.

In the example shown in FIG. 7, the first blowing unit 310 is provided on the upstream side of the accommodation portion 210 in the y direction. Further, the second blowing unit 320 is provided on the downstream side of the accommodation portion 210 in the x direction. In addition, the first blowing unit 310 blows air onto a first edge portion 61 located on the upstream side of the periphery of the paper P in the y direction, and the second blowing unit 320 blows air onto a third edge portion 63 located on the downstream side of the x direction of the periphery of the paper P.

In this example, the air flow path through the first blowing unit 310 and the air flow path through the second blowing unit 320 intersect with each other and overlap at the intersecting portion.

In this way, in a case in which the air flow path through the first blowing unit 310 and the air flow path through the second blowing unit 320 overlap at least in part, the air from the first blowing unit 310 and the air from the second blowing unit 320 may affect each other. In this case, the air volume is adjusted excessively, and it is difficult to maintain the floating state of the paper P in a normal state.

In contrast, as described above, in a case in which it is necessary to adjust both the air volume from the first blowing unit 310 and the air volume from the second blowing unit 320, the control unit 90 according to the present exemplary embodiment adjusts the air volume from one of the first blowing unit 310 and the second blowing unit 320 rather than adjusting the air volumes in parallel. Accordingly, excessive adjustment of the air volume is suppressed, compared to a case in which the air volumes of the first blowing unit 310 and the second blowing unit 320 are adjusted in parallel.

Although the exemplary embodiments of the present invention have been described above, the technical scope of the present invention is not limited to the scope described in the above-described exemplary embodiments. It is apparent from claims that exemplary embodiments in which various modifications or improvements are added to the above-mentioned exemplary embodiments are also included in the technical scope of the present invention.

### Supplementary Note

(((1)))

A recording medium supply device comprising:
an accommodation portion that accommodates a plurality of stacked recording media;
a first blowing unit that blows air at a first position on a periphery of the recording media accommodated in the accommodation portion;
a second blowing unit that blows air at a second position different from the first position on the periphery of the recording media accommodated in the accommodation portion to overlap an air flow path through the first blowing unit;
a first detection unit that detects a floating state of the recording media at the first position;
a second detection unit that detects a floating state of the recording media at the second position; and
an adjustment unit that adjusts an air volume by one of the first blowing unit and the second blowing unit based on detection results by the first detection unit and the second detection unit.
   (((2)))

The recording medium supply device according to (((1))),
wherein the adjustment unit adjusts the air volume by one of the first blowing unit and the second blowing unit, and then adjusts an air volume by the other of the first blowing unit and the second blowing unit.
   (((3)))

The recording medium supply device according to (((2))),
wherein the adjustment unit, after adjusting the air volume by one of the first blowing unit and the second blowing unit, does not adjust the air volume by the other of the first blowing unit and the second blowing unit in a case in which the floating states of the recording media detected by the first detection unit and the second detection unit satisfy a predetermined requirement.
   (((4)))

The recording medium supply device according to any one of (((1))) to (((3))),
wherein the adjustment unit calculates adjustment amounts for adjusting air volumes of the first blowing unit and the second blowing unit based on the detection results by the first detection unit and the second detection unit, and adjusts the air volume by one of the first blowing unit and the second blowing unit, which has a larger adjustment amount.
   (((5)))

The recording medium supply device according to (((4))),
wherein the adjustment unit adjusts the air volumes of both the first blowing unit and the second blowing unit in parallel in a case in which the adjustment amounts of the first blowing unit and the second blowing unit are equal to or less than a predetermined reference value.
   (((6)))

The recording medium supply device according to (((1))),
wherein the adjustment unit performs either a single adjustment to adjust the air volume by one of the first blowing unit and the second blowing unit or a parallel adjustment to adjust air volumes by both the first blowing unit and the second blowing unit in parallel, depending on a type of recording media accommodated in the accommodation portion.
   (((7)))

The recording medium supply device according to (((6))),
wherein the adjustment unit performs the single adjustment in a case in which a width of the recording media accommodated in the accommodation portion is equal to or smaller than a predetermined reference width.
   (((8)))

The recording medium supply device according to (((6))),
wherein the adjustment unit performs the single adjustment in a case in which a basis weight of the recording media accommodated in the accommodation portion is equal to or less than a predetermined reference amount.
   (((9)))

The recording medium supply device according to (((1))),
wherein the adjustment unit performs either a single adjustment to adjust the air volume by one of the first blowing unit and the second blowing unit or a parallel adjustment to adjust air volumes by both the first blowing unit and the second blowing unit in parallel depending on a selection of a user.
   (((10)))

The recording medium supply device according to any one of (((1))) to (((9))),
wherein the detection of the floating state of the recording media by the first detection unit and the detection of the floating state of the recording media by the second detection unit are performed in parallel.
   (((11)))

The recording medium supply device according to any one of (((1))) to (((10))),
wherein the first position and the second position are located at two opposing edge portions of the periphery of the recording media.
   (((12)))

The recording medium supply device according to any one of (((1))) to (((11))),
wherein the air flow path through the first blowing unit and an air flow path through the second blowing unit overlap in both a stacking direction of the recording media and a surface direction of the recording media.
   (((13)))

An image forming apparatus comprising:
the recording medium supply device according to any one of (((1))) to (((12)));
a transport section that transports a recording medium floated by air in the recording medium supply device; and
an image forming section that forms an image on the recording medium transported by the transport section.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium supply device comprising:
an accommodation portion that accommodates a plurality of stacked recording media;
a first blowing unit that blows air at a first position on a periphery of the recording media accommodated in the accommodation portion;
a second blowing unit that blows air at a second position different from the first position on the periphery of the recording media accommodated in the accommodation portion to overlap an air flow path through the first blowing unit;
a first detection unit that detects a floating state of the recording media at the first position;
a second detection unit that detects a floating state of the recording media at the second position; and
an adjustment unit that adjusts an air volume by one of the first blowing unit and the second blowing unit based on detection results by the first detection unit and the second detection unit.

2. The recording medium supply device according to claim 1,
wherein the adjustment unit adjusts the air volume by one of the first blowing unit and the second blowing unit, and then adjusts an air volume by the other of the first blowing unit and the second blowing unit.

3. The recording medium supply device according to claim 2,
wherein the adjustment unit, after adjusting the air volume by one of the first blowing unit and the second blowing unit, does not adjust the air volume by the other of the first blowing unit and the second blowing unit in a case in which the floating states of the recording media detected by the first detection unit and the second detection unit satisfy a predetermined requirement.

4. The recording medium supply device according to claim 1,
wherein the adjustment unit calculates adjustment amounts for adjusting air volumes of the first blowing unit and the second blowing unit based on the detection results by the first detection unit and the second detection unit, and adjusts the air volume by one of the first blowing unit and the second blowing unit, which has a larger adjustment amount.

5. The recording medium supply device according to claim 4,
wherein the adjustment unit adjusts the air volumes of both the first blowing unit and the second blowing unit in parallel in a case in which the adjustment amounts of the first blowing unit and the second blowing unit are equal to or less than a predetermined reference value.

6. The recording medium supply device according to claim 1,
wherein the adjustment unit performs either a single adjustment to adjust the air volume by one of the first blowing unit and the second blowing unit or a parallel adjustment to adjust air volumes by both the first blowing unit and the second blowing unit in parallel, depending on a type of recording media accommodated in the accommodation portion.

7. The recording medium supply device according to claim 6,
wherein the adjustment unit performs the single adjustment in a case in which a width of the recording media accommodated in the accommodation portion is equal to or smaller than a predetermined reference width.

8. The recording medium supply device according to claim 6,
wherein the adjustment unit performs the single adjustment in a case in which a basis weight of the recording media accommodated in the accommodation portion is equal to or less than a predetermined reference amount.

9. The recording medium supply device according to claim 1,
wherein the adjustment unit performs either a single adjustment to adjust the air volume by one of the first blowing unit and the second blowing unit or a parallel adjustment to adjust air volumes by both the first blowing unit and the second blowing unit in parallel depending on a selection of a user.

10. The recording medium supply device according to claim 1,
wherein the detection of the floating state of the recording media by the first detection unit and the detection of the floating state of the recording media by the second detection unit are performed in parallel.

11. The recording medium supply device according to claim 1,
wherein the first position and the second position are located at two opposing edge portions of the periphery of the recording media.

12. The recording medium supply device according to claim 1,
wherein the air flow path through the first blowing unit and an air flow path through the second blowing unit overlap in both a stacking direction of the recording media and a surface direction of the recording media.

13. An image forming apparatus comprising:
the recording medium supply device according to claim 1;
a transport section that transports a recording medium floated by air in the recording medium supply device; and
an image forming section that forms an image on the recording medium transported by the transport section.

14. An image forming apparatus comprising:
the recording medium supply device according to claim 2;
a transport section that transports a recording medium floated by air in the recording medium supply device; and
an image forming section that forms an image on the recording medium transported by the transport section.

15. An image forming apparatus comprising:
the recording medium supply device according to claim 3;
a transport section that transports a recording medium floated by air in the recording medium supply device; and
an image forming section that forms an image on the recording medium transported by the transport section.

16. An image forming apparatus comprising:
the recording medium supply device according to claim 4;
a transport section that transports a recording medium floated by air in the recording medium supply device; and
an image forming section that forms an image on the recording medium transported by the transport section.

17. An image forming apparatus comprising:
the recording medium supply device according to claim 5;
a transport section that transports a recording medium floated by air in the recording medium supply device; and
an image forming section that forms an image on the recording medium transported by the transport section.

18. An image forming apparatus comprising:
the recording medium supply device according to claim 6;
a transport section that transports a recording medium floated by air in the recording medium supply device; and
an image forming section that forms an image on the recording medium transported by the transport section.

19. An image forming apparatus comprising:
the recording medium supply device according to claim 7;
a transport section that transports a recording medium floated by air in the recording medium supply device; and
an image forming section that forms an image on the recording medium transported by the transport section.

20. An image forming apparatus comprising:
the recording medium supply device according to claim 8;
a transport section that transports a recording medium floated by air in the recording medium supply device; and
an image forming section that forms an image on the recording medium transported by the transport section.
